(19) United States
(12) Patent Application Publication
(10) Pub. No.: US 2006/0012791 A1
(43) Pub. Date: Jan. 19, 2006

(54) Wafer inspection system

(76) Inventors: Silviu Reinhorn, Mevaseret Zion (IL); Daniel Some, Ashdod (IL); Gilad Almogy, Givatayim (IL)

Correspondence Address: Tarek N. Fahmi;Applied Materials, Inc., Patent Counsel, P.O. Box 450A, Santa Clara, CA, 95052, US

(21) Appl. No.: 11/158,733

(22) Filed: Jun. 21, 2005

Related U.S. Application Data
(60) Provisional application No. 60/581,855, filed on Jun. 22, 2004.

(51) Int. Cl. G01N 21/88

(52) U.S. Cl. 356/432; 356/237.1

(57) ABSTRACT

Apparatus for inspecting a surface, including a plurality of pump sources having respective pump optical output ends and providing respective pump beams through the pump optical output ends, and a plurality of probe sources having respective probe optical output ends and providing respective probe beams through the probe optical output ends. There is an alignment mounting which holds the respective pump optical output ends and probe optical output ends in equal respective effective spatial offsets, and optics which convey the respective pump beams and probe beams to the surface, so as to generate returning radiation from a plurality of respective locations thereon, and which convey the returning radiation from the respective locations. The apparatus includes a receiving unit which is adapted to receive the returning radiation and which is adapted to determine a characteristic of the respective locations in response thereto.

### CROSS-REFERENCE TO RELATED APPLICATION

This application claims the benefit of U.S. Provisional Patent Application 60/581,855, filed 22 Jun. 2004, which is incorporated herein by reference.

### FIELD OF THE INVENTION

The present invention relates generally to inspection systems, and specifically wafer inspection systems for detecting and localizing electrical defects.

### BACKGROUND OF THE INVENTION

Inspection of wafers, both for defects in wafer features and to confirm that the features conform to specified parameters, is an integral part of the wafer fabrication process. One of the methods known in the art for performing such an inspection uses an opto-thermal pump/probe technique. In this technique a first optical source (the pump) heats a location of the wafer, and second optical source (the probe) investigates the effect of the heating to determine a property of the location, such as its resistance.

U.S. Pat. No. 4,521,118, to Rosencwaig, whose disclosure is incorporated herein by reference, describes generating and measuring thermal waves in a sample. Thermal waves are generated by local periodic heating of an area of the sample with a laser pump beam. The waves are detected with a laser probe, which is focused on a portion of the area, and reflects from the portion. The angular displacement of the reflected beam is used to detect the thermal waves. The disclosure states that the thermal waves make sub-surface thermal features of the sample visible.

U.S. Pat. No. 4,632,561, to Rosencwaig et al., whose disclosure is incorporated herein by reference, describes a method and apparatus for evaluating features of a sample. A periodic laser pump source supplies energy to a surface of a sample, generating thermal and/or plasma waves from the energized area of the surface. A probe laser is directed to the area, and scatters from the area. Variations in the intensity of the scattered beam are used to evaluate the area.

U.S. Pat. No. 4,634,290, to Rosencwaig et al., whose disclosure is incorporated herein by reference, describes a method for measuring thermal waves in a sample, based on measuring changes in reflectivity of a sample surface. The sample is energized with a periodic laser pump beam, and a laser probe is directed to the sample. Changes in intensity of reflected probe light are used to detect the thermal waves.

U.S. Pat. No. 4,636,088, to Rosencwaig et al., whose disclosure is incorporated herein by reference, describes apparatus similar to that described in U.S. Pat. No. 4,634,290. The '088 disclosure describes how the changes in intensity of the reflected probe light may be used to evaluate surface conditions of the sample.

U.S. Pat. No. 5,228,776, to Smith et al., whose disclosure is incorporated herein by reference, describes apparatus for evaluating characteristics of a sample. An intensity modulated pump beam is focused onto one spot of the sample. A non-modulated probe beam is focused onto another spot, spaced laterally and vertically from the first spot. The modulated power of the reflected probe beam provides information about parts of the sample between the two spots.

U.S. Pat. No. 6,019,504, to Adams, whose disclosure is incorporated herein by reference, describes a method for photo-thermally examining a surface. The surface is irradiated with a plurality of exciting beams generated from one laser. Each of the beams heats the surface at a spot on the surface, and infra-red detectors monitor the heat radiation emitted by each of the spots. U.S. Pat. No. 6,054,868, to Borden et al., whose disclosure is incorporated herein by reference, describes apparatus and a method for measuring a property of a layer in a multi-layered structure. A pump beam is focused onto a region, to heat the region. The pump beam is modulated at a frequency chosen so that a majority of the heat transfers from the region by diffusion. A probe beam is also focused on the region and the reflected modulated probe beam is measured. The disclosure states that the measurement may be used to determine a resistance of a conductive line comprising the region.

U.S. Patent Application Publication 2002/0027941, to Schlagheck et al., whose disclosure is incorporated herein by reference, describes a method and apparatus for detection of defects. A heat pulse is injected into the object being inspected. A series of thermal images of the object over time, resulting from the heat pulse, are compared with a reference, and the comparison is stated to enable defects to be identified.

U.S. Patent Application Publication 2003/0165178, to Borden et al., whose disclosure is incorporated herein by reference, describes identifying defects in a conductive structure of a wafer. An incoming beam, which may be an electron or a laser beam, is used to heat the conductive structure. A thermal imager or a probe beam is used to measure the temperature of the structure, which is stated to indicate the integrity or defectiveness of the conductive structure.

### SUMMARY OF THE INVENTION

In an embodiment of the present invention, a plurality of pump sources provides respective pump beams, and a plurality of probe sources provides respective probe beams. Each pump source has a respective pump optical end, and each probe source has a respective probe optical end. Each pump or probe source typically comprises a pump or probe radiation generator such as a laser photodiode coupled to a fiber optic, the end of the fiber optic acting as the pump or probe optical end and transmitting a pump or probe beam. An alignment mounting holds the respective pump optical output ends and probe optical output ends so that the respective pairs of ends have equal effective spatial offsets.

Optics convey the pump and probe beams from the output ends to a surface, and focus the beams to an array of pump and probe spots on the surface, the optics typically being configured so that respective pairs of pump and probe spots have equal spot offsets on the surface.

The spots generate returning radiation from respective locations on the surface, and a receiving unit determines a characteristic of the respective locations, such as a resistance of a structure thereat, from the returning radiation. By generating a plurality of pump and probe spots having equal offsets at the surface being inspected, inspection of large areas of the surface may be performed reproducibly and in a short time.

In an alternative embodiment of the present invention, one pump source generates pump radiation, and one probe source generates probe radiation. A plurality of transparent pump elements, typically an array of micro-lenses, are arranged to receive different respective pump portions of the pump radiation and to output the respective pump portions as the respective pump beams. A similar plurality of transparent probe elements are arranged to receive different respective probe portions of the probe radiation and to output the respective probe portions as the respective probe beams. In the alternative embodiment the alignment mounting holds the transparent pump elements and transparent probe elements so that respective pump and probe elements have the equal effective spatial offsets. The alternative embodiment comprises the optics and the receiving unit described above, the optics acting to convey the pump and probe beams from the transparent elements to form the array of spots on the surface.

The one or more pump sources and the one or more probe sources are typically configured to operate at different wavelengths. The different wavelengths enable probe radiation in the returning radiation to be differentiated from any returning pump beam radiation. The pump beams may be intensity modulated at a modulation frequency, in which case the receiving unit is configured to detect the modulation frequency component in the probe wavelength comprised in the returning radiation.

In a further alternative embodiment of the present invention, a multiple-beam system for inspecting one of the locations on the surface is disclosed. The multiple-beam system generates one pump beam which irradiates the location with a pump spot, and first and second probe sources generate respective first and second probe beams which also irradiate the location with first and second probe spots. The first and second probe beams interact with the location to produce respective first returning radiation and second returning radiation from the location. Using more than one probe beam per pump beam to inspect the location considerably enhances the ability of the system to determine characteristics of the location. The multiple-beam system may be configured so that a plurality of sets of pump and first and second probe spots irradiate a respective plurality of locations on the surface simultaneously, generally as described above.

Respective wavelengths of the pump beam and the first and second probe beams may be set to have different values. The different wavelengths enable the first and second returning radiations to be differentiated from each other, and from any returning pump beam radiation.

The present invention will be more fully understood from the following detailed description of the embodiments thereof, taken together with the drawings, a brief description of which follows.

### BRIEF DESCRIPTION OF THE DRAWINGS

FIG. 1 is a schematic diagram illustrating a wafer inspection apparatus, according to an embodiment of the present invention;

FIG. 2A is a schematic diagram showing details of a layout of an array imaged onto a wafer being inspected in the apparatus of FIG. 1, and FIG. 2B is a schematic diagram showing locations of the array on a surface of the wafer, according to an embodiment of the present invention;

FIG. 3 is a schematic diagram illustrating a wafer inspection apparatus, according to an alternative embodiment of the present invention;

FIG. 4 is a schematic diagram illustrating a wafer inspection apparatus, according to a further embodiment of the present invention and

FIG. 5 illustrates offsets between spots imaged onto a wafer being inspected, according to an embodiment of the present invention.

### DETAILED DESCRIPTION OF EMBODIMENTS

One embodiment of the present invention provides apparatus for inspecting a surface, including:

a plurality of pump sources having respective pump optical output ends and providing respective pump beams through the pump optical output ends;

a plurality of probe sources having respective probe optical output ends and providing respective probe beams through the probe optical output ends;

an alignment mounting which holds the respective pump optical output ends and probe optical output ends in equal respective effective spatial offsets;

optics which convey the respective pump beams and probe beams to the surface, so as to generate returning radiation from a plurality of respective locations thereon, and which convey the returning radiation from the respective locations; and

a receiving unit which is adapted to receive the returning radiation and which is adapted to determine a characteristic of the respective locations in response thereto.

Typically, the plurality of pump sources operate at a pump wavelength, and the plurality of probe sources operate at a probe wavelength different from the pump wavelength.

Each of the respective pump beams may be modulated at a modulation frequency, and the returning radiation includes returning radiation from the probe beams conveyed to the surface at the modulation frequency.

The optics may convey the respective pump beams and probe beams to the surface so as to form respective sets of spots at the respective locations. Typically, the alignment mounting and the optics are configured to apply an equal spot offset to each of the sets of spots. The spot offset may be a zero or a non-zero vector.

Each pump source typically includes a pump radiation source coupled to convey the respective pump beam into a fiber optic having a transmitting end, and the pump optical output end includes the transmitting end.

Each probe source may include a probe radiation source coupled to convey the respective probe beam into a fiber optic having a transmitting end, and the probe optical output end may include the transmitting end.

In one embodiment, the alignment mounting includes a probe mount which holds the probe optical output ends and a pump mount which holds the pump optical output ends, and the probe mount and the pump mount have the same geometric configuration.

In an alternative embodiment, the optics include a scanning unit which is adapted to implement a scan of the respective pump beams and probe beams across the surface, and the plurality of respective locations include a plurality of areas of the surface determined in response to the scan. Typically, the scanning unit is adapted to set a parameter of the scan according to at least one of a property of a structure at one of the respective locations and the characteristic of the one respective location.

In some embodiments, wherein the plurality of pump sources and/or the plurality of probe sources include a Dammann grating.

A further embodiment of the present invention provides apparatus for inspecting a surface, including:

a pump source which generates pump radiation;

a plurality of transparent pump elements arranged to receive different respective pump portions of the pump radiation and to output the respective pump portions as respective pump beams;

a probe source which generates probe radiation;

a plurality of transparent probe elements arranged to receive different respective probe portions of the probe radiation and to output the respective probe portions as respective probe beams;

an alignment mounting which holds the respective transparent pump elements and the respective transparent probe elements in equal respective effective spatial offsets;

optics which convey the respective pump beams and probe beams to the surface, so as to generate returning radiation from a plurality of respective locations thereon, and which convey the returning radiation from the respective locations; and

a receiving unit which is adapted to receive the returning radiation and which is adapted to determine a characteristic of the respective locations in response thereto.

Typically the pump radiation has a pump wavelength, and the probe radiation has a probe wavelength different from the pump wavelength.

Each of the respective pump beams may be modulated at a modulation frequency, in which case the returning radiation includes returning radiation, from the probe beams conveyed to the surface, at the modulation frequency.

The optics may convey the respective pump beams and probe beams to the surface so as to form respective sets of spots at the respective locations. The alignment mounting and the optics may be configured to apply an equal spot offset to each of the sets of spots, the spot offset being a zero or a non-zero vector.

In an embodiment, the optics include a scanning unit which is adapted to implement a scan of the respective pump beams and probe beams across the surface, and the plurality of respective locations include a plurality of areas of the surface determined in response to the scan. The scanning unit may be adapted to set a parameter of the scan according to at least one of a property of a structure at one of the respective locations and the characteristic of the one respective location.

A yet further embodiment of the present invention provides apparatus for inspecting a surface, including:

a pump source which is adapted to irradiate a location on the surface with a pump beam;

a first probe source which is adapted to perform a first probe irradiation of the location so as to generate first returning radiation therefrom;

a second probe source which is adapted to perform a second probe irradiation of the location so as to generate second returning radiation therefrom; and

a receiving unit which is adapted to receive the first and the second returning radiations and which is adapted to determine a characteristic of the location in response to at least one of the returning radiations.

Typically, the pump source, the first probe source, and the second probe source operate at different wavelengths.

The first probe irradiation may be modulated at a modulation frequency, and the receiving unit may be adapted to receive the first and the second returning radiations at the modulation frequency.

The apparatus may include a polarization element which is adapted to polarize at least one of the pump source, the first probe source, and the second probe source.

Alternatively or additionally, the apparatus may include a scanning unit which is adapted to scan respective radiations from the pump source, the first probe source, and the second probe source across the surface, and the location includes a plurality of areas of the surface determined in response to the scan. The scanning unit may be at least one of a plane mirror, a curved mirror, a polygonal mirror, and an acousto-optic vibrator. The scanning unit may be adapted to set a parameter of a scan according to at least one of a property of a structure at the location and the characteristic of the location. The structure typically includes a conductive line, the property may include a direction of the conductive line, and the characteristic may include a resistance of the conductive line.

In a disclosed embodiment the location includes an array of one or more regions on the surface, and for each region the pump source irradiates a pump spot in the region, the first probe source irradiates a first probe spot in the region, and the second probe source irradiates a second probe spot in the region. In one embodiment, at least two of the pump spot, the first probe spot, and the second probe spot have the same position. Alternatively, at least one of the first probe spot and the second probe spot have a non-zero offset from the pump spot. Further alternatively, at least two of the pump spot, the first probe spot, and the second probe spot at least partially overlap. Yet further alternatively, the pump spot, the first probe spot, and the second probe spot do not overlap.

The disclosed embodiment may include a positioning unit which is adapted to position the array at one or more areas of the surface.

The one or more areas may include two areas which do not overlap and/or two areas which at least partially overlap.

In the disclosed embodiment the array may include a first array of one or more first regions, and the location may include a second array of one or more second regions, and for each second region the pump source irradiates the pump spot in the second region, the first probe source irradiates the first probe spot in the second region, and the second probe source does not irradiate the second region.

A yet alternative embodiment of the present invention provides a method for inspecting a surface, including:

generating a plurality of pump beams from respective pump sources;

outputting the respective pump beams from respective pump optical output ends of the respective pump sources;

generating a plurality of probe beams from respective probe sources;

outputting the respective probe beams from respective probe optical output ends of the respective probe sources;

holding the respective pump optical output ends and probe optical output ends in equal respective effective spatial offsets;

conveying the respective pump beams and probe beams to the surface, so as to generate returning radiation from a plurality of respective locations thereon; and

receiving the returning radiation and determining a characteristic of the respective locations in response to received returning radiation.

One disclosed embodiment of the present invention provides a method for inspecting a surface, including:

generating pump radiation from a pump source;

arranging a plurality of transparent pump elements to receive different respective pump portions of the pump radiation and to output the respective pump portions as respective pump beams;

generating probe radiation from a probe source;

arranging a plurality of transparent probe elements to receive different respective probe portions of the probe radiation and to output the respective probe portions as respective probe beams;

holding the respective transparent pump elements and the respective transparent probe elements in equal respective effective spatial offsets;

conveying the respective pump beams and probe beams to the surface, so as to generate returning radiation from a plurality of respective locations thereon; and

receiving the returning radiation and determining a characteristic of the respective locations in response to received returning radiation.

An alternative disclosed embodiment of the present invention provides a method for inspecting a surface, including:

irradiating a location on the surface with a pump beam;

irradiating the location with a first probe beam so as to generate first returning radiation from the location;

irradiating the location with a second probe beam so as to generate second returning radiation from the location;

receiving the first returning radiation and the second returning radiation; and

determining a characteristic of the location in response to at least one of the first and the second returning radiations.

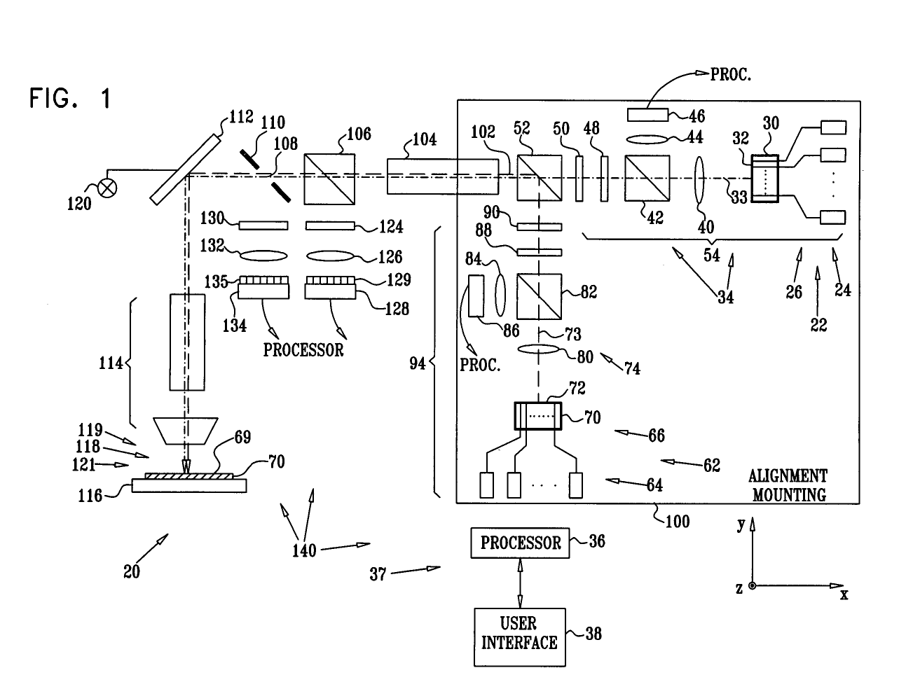

Reference is now made to FIG. 1, which is a schematic diagram illustrating a wafer inspection apparatus 20, according to an embodiment of the present invention. Apparatus 20 is used to inspect features on and/or close to a surface of a wafer 70, typically a wafer produced in a semiconductor fabrication process, and the description hereinbelow is directed, by way of example, to such a use. However, it will be appreciated that apparatus 20 may be used to inspect features on and/or close to a surface of materials produced in other processes. Apparatus 20 is typically incorporated into an inspection tool wherein wafer 70 is being fabricated, although herein the inspection tool and elements associated with the inspection tool are not shown for reasons of clarity.

As is described in more detail below, the inspection process used by apparatus 20 is based on irradiating a top surface 69 of wafer 70 with radiation that heats the wafer, herein termed pump radiation. The wafer is inspected by irradiating the wafer with one or more inspection radiations, herein termed probe radiations, and receiving and analyzing the probe radiation that returns from the wafer. The analysis is performed by a processor 36, which also operates apparatus 20 and its component elements. A user interface 38 coupled to the processor allows an operator of apparatus 20 to control the operation of the processor, and to see the results.

Some elements of apparatus 20 are assumed, by way of example, to be positioned relative to a set of orthogonal x, y, z coordinate axes, where the x and y axes are in the plane of the paper and the z axis is out of the plane of the paper. For example, surface 69 is assumed to lie in an xz plane. It will be appreciated, however, that the assumption that some elements of apparatus 20 are positioned relative to a particular axis or set of axes is purely for the purposes of clarity in the following description, and that the elements may be positioned in any convenient orientation.

Apparatus 20 comprises a plurality of pump sources 22, each pump source comprising a pump laser 24, typically a diode laser, coupled to a fiber optic 26. Each pump laser is selected to generate substantially the same pump wavelength; in an embodiment of the present invention, the pump wavelength is selected to be in a range 400 nm-550 nm. However, it will be appreciated that the pump wavelength may be selected to have any other convenient value. Each fiber optic 26 is led to a fiber-optic mount 30 which retains the fiber optics in fixed positions relative to each other. Ends 32 of each fiber optic within the mount are configured to be able to radiate from the mount. Thus, ends 32 are fixed in position relative to each other, and transmit a plurality of pump beams 34.

The output from each end 32 is intensity modulated at a frequency f. Typically the modulation of beams 34 may be accomplished by a synchronization unit 37 that synchronizes a receiving unit 140, the position of a scanning mirror 112, and the timing of the modulation. Receiving unit 140 acts as an image processor, and its elements are described in more detail below. Synchronization unit 37 applies modulation directly to each laser 24.

Mount 30 is configured to retain ends 32 in a pre-determined geometric arrangement, typically a one-dimensional (1-D) straight line, or alternatively a two-dimensional (2-D) array. In an embodiment of the present invention for a 1-D straight line, mount 30 comprises a planar silicon substrate onto which v-shaped grooves are etched, each v-shaped groove retaining one fiber optic. Other 1-D and 2-D mounts may advantageously be made by generally similar processes, such as by etching a 2-D array of holes in a planar silicon substrate, each hole retaining a fiber optic. Such processes will be familiar to those skilled in the art, and mounts made by these processes give extremely precise and reproducible relative alignment of the terminations of the fiber optics. All such mounts and processes are assumed to be comprised within the scope of the present invention.

Beams 34 are collimated to a plurality of parallel beams by a collimation lens 40. Parallel beams 34 pass through a first beam splitter 42, which diverts a portion of the energy of the beams via a focusing lens 44 to a pump reference detector array 46. Processor 36 receives respective signals generated by the array, and uses the signals for normalization of received image signals. Beams 34 pass through a half-wave plate 48 and a quarter-wave plate 50, acting to control the beam polarization, to a beam combiner 52. Combiner 52 is configured to transmit wavelengths of beams 34, and to reflect wavelengths of beams from a probe beam generator 94, described below. The path followed by beams 34 is shown schematically as a solid line 33.

The components generating beams 34, i.e., those numbered 22, 24, 26, 30, 40, 42, 44, 46, 48, and 50, comprise a pump beam generator 54 which generates the plurality of pump beams 34.

Probe beam generator 94 comprises a plurality of probe sources 62, each probe source comprising a probe laser 64, typically a diode laser, coupled to a fiber optic 66. Each probe laser is selected to generate substantially the same probe wavelength, which, in one embodiment of the present invention, is selected to be in a range 600 nm -800 nm. Each fiber optic 66 is led to a fiber-optic mount 70 which retains the fiber optics in fixed positions relative to each other. Ends 72 of each fiber optic 66 within the mount are configured to be able to radiate from the mount. Thus, ends 72 are fixed in position relative to each other, and transmit a plurality of probe beams 74. The path followed by beams 74 is shown schematically as a broken line 73.

Mount 70 is configured as mount 30, so as to retain ends 72 in substantially the same pre-determined geometric arrangement as ends 32 of mount 30.

Generator 94 further comprises a collimating lens 80, a beam splitter 82, a focusing lens 84, a probe reference detector array 86, a half-wave plate 88, and a quarter-wave plate 90, which are configured in the same relative arrangement and perform substantially the same functions as components 40, 42, 44, 46, 48, and 50 respectively. Thus, generator 94 transmits a plurality of parallel probe beams 74 to beam combiner 52. However, unlike pump beam generator 54, processor 36 does not intensity modulate probe beams 74, and uses the signals derived from array 86 to normalize the reflected signals so as to eliminate probe laser noise. The beams output from combiner 52, comprising parallel beams 34 and parallel beams 74, are herein termed beam bundle 102.

Components of generators 54 and 94 and combiner 52 are mounted on an alignment mounting 100 so that, from the point of view of combiner 52, each respective end 32 and end 72 have the same effective spatial offset with respect to each other. I.e., the spatial offset of respective images of ends 72 in combiner 52, compared to respective ends 32, is the same. The components are also mounted so that pairs of respective pump and probe beams of bundle 102, from each pair of ends 32 and 72, have the same relative beam offset after traversing beam combiner 52. Mounting 100 typically comprises an optical bench upon which components of the generators, such as mounts 30 and 70, may be adjustably positioned. However, substantially any convenient mounting that holds components of generators 54 and 94 so that the relative spatial offsets of ends 32 and 72 are effectively the same, and so that the beam offsets of the beams output from combiner 52 are also the same, may be used as mounting 100.

Bundle 102 traverses a set of relay optics 104, a beam splitter 106, and an aperture 108 in a mirror 110, to scanning mirror 112 which is configured to scan the bundle in two dimensions on surface 69. Optics 104 images the beam bundle pupil onto mirror 112; the functions of beam splitter 106 and mirror 110 are described below.

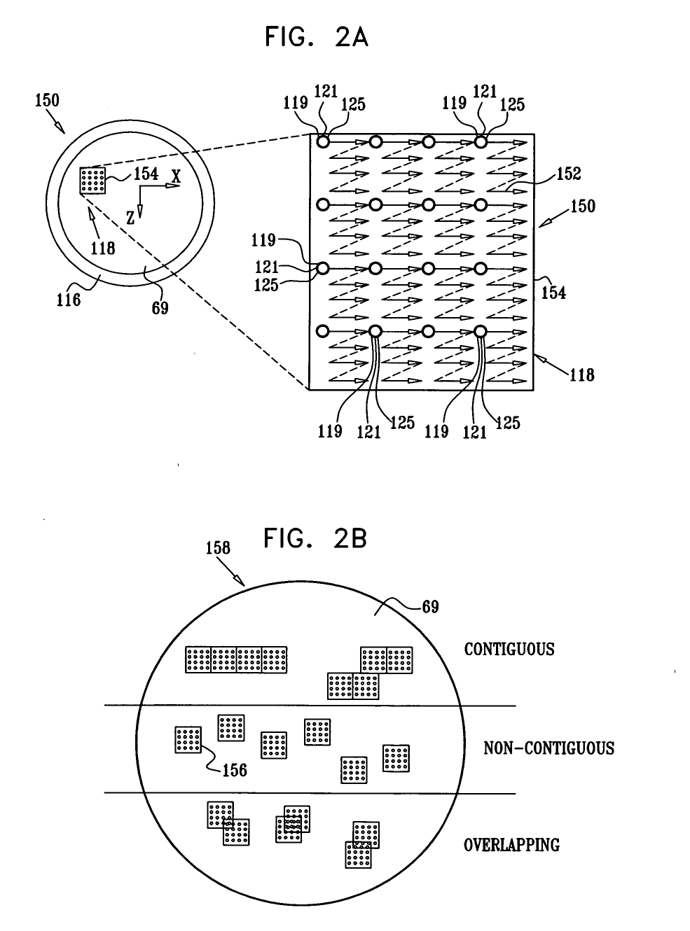

Scanning mirror 112 reflects beam bundle 102, via a set of relay and focusing optics 114, to top surface 69 of wafer 70. Wafer 70 is mounted and supported on a stage 116, typically a motion stage which is able to alter the position of wafer in the x, y and z directions. Optics 114 are configured to focus beam bundle 102 to an array 118 of spots on surface 69, array 118 comprising sub-arrays 119 of pump spots formed by pump beams 34, and sub-arrays 121 of probe spots formed by probe beams 74. Typical configurations for array 118 are described in more detail below with respect to FIGS. 2A and 2B. Scanning mirror 112 scans array 118 over surface 69, and details of typical scans are described in more detail below with respect to FIG. 2A. Scanning mirror 112 is operated by a motion stage 120, the mirror and stage 120, together with stage 116, being configured so that array 118 may be positioned at substantially any point on surface 69. It will be appreciated that apparatus 20 may comprise other scanning units, known in the art, for scanning array 118 over surface 69. For example, mirror 112 may comprise a single plane or curved mirror, and/or a polygonal mirror formed from a number of different plane or curved mirrors. Such mirrors may be mechanically or electro-mechanically scanned. Alternatively or additionally, scanning of array 118 may be accomplished using an acousto-optic deflector, or by other means known in the art.

In some embodiments of the present invention, one or more of pump beams 34 and probe beams 74 are linearly polarized by their respective half and quarter wave plates; alternatively or additionally one or more of the beams are circularly or elliptically polarized after traversing their plates.

As described above, beam bundle 102 generates array 118 at the surface 69 of wafer 70, and the beam bundle interacts with the surface to generate reflected and/or scattered radiation from the locations on the surface irradiated by the array. The reflected and/or scattered radiation is hereinbelow referred to as returning radiation. The elements of apparatus 20 are configured so that optics 114 collect at least a portion of the returning radiation, and together with mirror 112 direct the collected portion to initially traverse substantially the same path as the incoming beam bundle. Thus the collected portion of the returning radiation, returns to mirror 110 and beam splitter 106.

The returning radiation comprises specular and scattered radiation from the pump and probe spots of array 118. The specular radiation passes through aperture 108 to beam splitter 106. Splitter 106 is configured to be substantially transparent to pump beam radiation, and to partially reflect probe beam radiation. Thus, specular probe beam radiation is reflected by splitter 106, via a narrow band transmission filter 124 and focusing optics 126, to an imaging device 128. Optics 126 focus an image of the sub-array of probe spots of array 118, using the specular probe returning radiation from each of the spots, onto imaging device 128. Device 128 detects the specular reflected signals for each of the imaged probe spots, the signals being transferred to processor 36. Typically, device 128 and other image detectors described herein comprise an array of PIN diodes, an array of photodiodes, or an array of photo-multiplier tubes.

The scattered radiation is reflected by mirror 110, via a narrow band transmission filter 130 and focusing optics 132, to an imaging device 134 which detects scattered probe returning radiation. Optics 132 focus an image of the sub-array of probe spots of array 118, using the scattered probe returning radiation from each of the spots, onto device 134. Device 134 detects the scattered signals for each of the imaged probe spots, the signals being transferred to processor 36.

Filters 124 and 130 typically transmit probe wavelengths and are opaque to pump wavelengths. Imaging devices 128 and 134 typically comprise respective two dimensional array of charge coupled devices (CCDs) or diodes, each of which defines a pixel of its image. In one embodiment of the present invention, system 20 also comprises respective confocal pinhole arrays 129 and 135 in focal planes of lenses 126 and 132, the pinhole arrays corresponding to the arrangements of ends 72. Such confocal arrays act as masks for their respective imaging devices, preventing unwanted light, such as off-axis returning light, from reaching the devices. The arrays may also be advantageously used to remove returning radiation from a layer of wafer 70 not under inspection, and so enhance signal-to-background and signal-to-noise levels.

As stated above, processor 36 controls the adjustments of elements of the apparatus such as mirror 112, and processor 36 is in turn controlled by an operator of apparatus 20 via user interface 38. Processor 36 also receives the output from imaging devices 128 and 134, and processes the outputs to provide results of the inspection of wafer 70. Devices 128, 134, and processor 36 act as receiving unit 140 for apparatus 20 that generates the results. The results may be accessed by the apparatus operator via interface 38. The processing of the outputs from devices 128 and 134 is described in more detail below.

FIG. 2A is a schematic diagram showing details of a layout of array 118, and FIG. 2B is a schematic diagram showing locations of the array on surface 69, according to an embodiment of the present invention. As shown in FIG. 2A, array 118 is focused by optics 114 onto surface 69, in a position set by stage 116, and comprises sub-arrays of pump spots 119 and sub-arrays of probe spots 121 in a layout 150. Pump beam generating system 54 generates sub-array of spots 119, and probe beam generating system 94 generates sub-array of spots 121. FIGS. 2A and 2B illustrate, by way of example, that system 54 and system 94 generate sixteen sets of spots in substantially similar two-dimensional sub-arrays, each set of spots irradiating a respective location 125 of surface 69. It will be understood that each set of spots of the two sub-arrays have substantially the same spot offset, which is dependent on the setting of alignment mounting 100. It will also be understood that the spot offset may comprise a zero or a non-zero vector. Hereinbelow, except where otherwise stated, the offset is assumed to be zero, so that pairs of spots of the two sub-arrays are substantially concentric.

A specific pump spot of sub-array 119 heats the region of surface 69 where the spot irradiates the surface. The absorbed heat energy raises the mean temperature of the region to a value above the ambient temperature of the region existing before the irradiation. The mean temperatures of locations close to the irradiated region also rise above the ambient. The actual rise in temperature for any specific region is a function of a number of factors including the heat energy flowing into and out of the region, characteristics of the region such as its thermal capacity, and the thermal conductivities of areas close to the region. A region's temperature change affects other properties of the region, typically in a monotonic manner, the affected properties including the region's electrical properties such as its resistance, and the optical reflectivity of the region.

The optical reflectivity is given by equation (1):
R(T)=R₀+β·ΔT (1)

where R(T) is the reflectivity of the region at temperature T,

R₀ is the reflectivity at the ambient temperature,

β is a temperature coefficient of the reflectivity, in K⁻¹; typically β is in an approximate range 10⁻⁴−10⁻⁵ K⁻¹,

and ΔT is a change in temperature of the region from the ambient temperature.

A generally similar equation to equation (1) applies for the change of an electrical property of the region with temperature. Thus, by measuring the reflectivity using apparatus 20, the electrical property of a location may be determined; alternatively or additionally, the electrical property may be verified for acceptability.

A region irradiated by one of probe spots 121, assuming the region is heated to temperature T by a pump spot 119, changes its reflectivity according to equation (1). Since the pump beam heating the region has a modulation frequency f, the changed reflectivity is also modulated at frequency f, causing the intensity of the returning probe beam to be modulated at the same frequency. As stated above, the returning radiation is imaged by imaging devices 128 and 134. Processor 36 extracts the component of frequency f in the intensity of the images of devices 128 and 134, typically by a process of phase sensitive detection using a digital lock-in amplifier. The process typically comprises digitization at a 2 f rate or better, or if phase information is to be used, at a 4 f rate or better. By comparing the extracted component with the energy of the incident probe beam determined from probe reference detector array 86, the processor determines a reflectivity metric of the irradiated location. Processor 36 uses the reflectivity metric from each probe beam to determine if a characteristic of the location, such as its electrical properties, are within an acceptable range. Typically, processor 36 also uses each reflectivity metric to perform die-to-die and/or cell-to-cell comparisons, and may also generate an average of all the metrics for comparison with a pre-determined baseline.

Processor 36 scans array 118 with scanning mirror 112 across surface 69, typically according to a raster pattern. The scan of array 118 enables the processor to inspect an area substantially greater than the area covered by the array itself. An example of a scan 152 applied by mirror 112 is illustrated for layout 150, scan 152 comprising a raster scan which scans each set of concentric spots over a respective rectangular area, so that array 118 is scanned over a rectangle 154. Scan 152 is configured so that every point within rectangle 154 is scanned by one set of concentric spots, with substantially no overlap. It will be appreciated, however, that the scan of array 118 may be set to have one or more sets of concentric spots overlapping. Alternatively or additionally, the scan may be set so that some areas within rectangle 154 are not scanned. Furthermore, while scan 152 comprises scans parallel to the x axis, each successive scan being translated parallel to the z axis, other types of one or two dimensional scans may be implemented by mirror 112. Such scans include, but are not limited to, non-raster scans as well as scans that are not parallel or orthogonal to the x or z axes. It will thus be appreciated that the area scanned by array 118 may comprise a regular or an irregular shape.

Hereinbelow the area scanned by array 118 is assumed to be an area 156, and in order to inspect wafer 70 it is assumed that processor 36 scans a plurality of areas 158 generally similar to area 156. FIG. 2B illustrates possible areas 158. Processor 36 sets the position of each area 158 by adjusting stage 116. Depending on the configuration set by the operator of apparatus 20, areas 158 may be contiguous, or non-contiguous, or may at least partly overlap each other. Further examples of how surface 69 may be scanned are described below.

Processor 36 typically scans mirror 112 in one of two scanning modes. In a first mode, the mirror is moved then stopped, and the imaging for each pixel of the imaging devices is performed while the mirror is stopped. In a second mode, mirror 112 moves at a substantially constant velocity that is adjusted by processor 36 according to the integration time required for each of the pixels of the imaging devices. Alternatively or additionally, processor 36 may scan mirror 112 in a combination of the two modes.

As stated above, layout 150 comprises generally concentric spots 119 and 121. Alternatively, processor 36 may set the offsets between spots 119 and 121 to be a vector P₁, defined by equation (2). Each component x₁, z₁, of the vector is typically of the order of 1-2 radii of the pump or probe spots, although it will be understood that the components may be set to be any convenient real number.
P₁−(x₁,z₁); x₁,z₁, ε R (2)

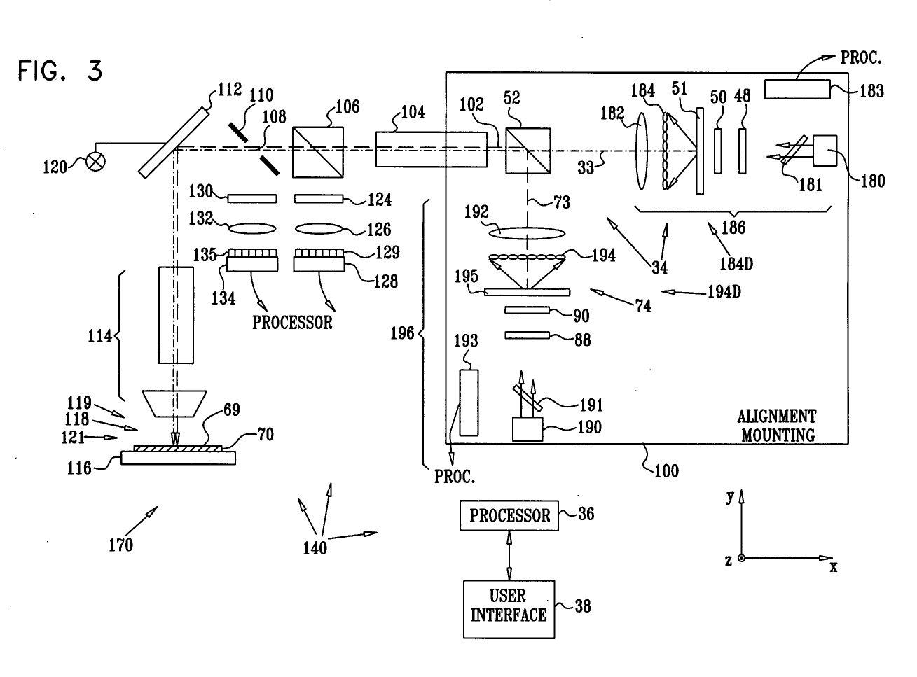

FIG. 3 is a schematic diagram illustrating a wafer inspection apparatus 170, according to an alternative embodiment of the present invention. Apart from the differences described below, the operation of apparatus 170 is generally similar to that of apparatus 20 (FIG. 1), such that elements indicated by the same reference numerals in apparatus 20 and apparatus 170 are generally identical in construction and in operation. A pump generator 186, instead of comprising the plurality of pump sources 22 having separate pump lasers 24 with their fiber optics as in generator 54, has one pump source 180, typically a laser source. Processor 36 intensity modulates the output of the pump source at frequency f, the modulation being performed either by direct modulation of the source or by using an AOM device after the source. Source 180 typically operates in the same range as lasers 24. In generator 186 source 180 radiates the modulated pump radiation via half-wave plate 48 and quarter-wave plate 50 to a beam expander 51. The beam from expander 51 then passes through a set of micro-lenses 184 and a converging lens 182, which replace termination 30 and lens 40 of apparatus 20, and which generate the plurality of parallel pump beams 34. Micro-lenses 184 are transparent elements which act as ends 32. Set 184 typically comprises a two dimensional plurality of lenses which produces a respective plurality of beams 24. A suitable set of micro-lenses is an FC-Q-100 array produced by Suss MicroOptics SA of Neuchatel, Switzerland.

Rather than using beam splitter 42, lens 44 and array 46 as in generator 54, generator 186 typically comprises a beam splitter 181 between source 180 and plate 48. Beam splitter 181 reflects a portion of the radiation from source 180 to a detector 183, and processor 36 uses the signal from detector 183 in substantially the same way as is described above for the signals from array 46.

Components of generator 186 are adjustably mounted on mounting 100.

Apparatus 170 also comprises a probe generator 196 instead of generator 94. Generator 196 is substantially similar to generator 186, comprising one probe source 190, a beam splitter 191, polarizing plates 88 and 90, a beam expander 195, a set of micro-lenses 194, a converging lens 192, and a detector 193, instead of the separate sources 64 of generator 94. Micro-lenses 194 are transparent elements which act as ends 72. Source 190 typically operates in the same range as lasers 64, and processor 36 uses the signal from detector 193 in substantially the same way as is described above for the signals from array 46. Set of micro-lenses 194 is substantially similar to set 184, so that probe beams 74 are the same in number as the plurality of pump beams 34, and have substantially the same geometric relationship with each other as the plurality of pump beams. Furthermore, processor 36 configures the sets of micro-lenses 184 and 194 to have the same respective effective spatial offsets.

Components of generator 196 are adjustably mounted on mounting 100, and the two sets of components are adjusted so that beam bundle 102, array 118 of pump and probe spots, and the offsets of the spots, are substantially as described above (FIGS. 2A and 2B).

In a further alternative embodiment of apparatus 170, pump generator 186 and/or probe generator 196 comprise respective Dammann gratings 184D and/or 194D in place of the micro-lenses described above, the Dammann gratings being mounted on mounting 100 and acting as respective ends 32 and 37. Dammann gratings are described in articles by Dammann et al. in Opt. Commun. 3, 312 (1971).and in Opt. Acta 24, 505 (1977). It will be understood that if a Dammann grating is used, lens 182 and/or lens 192 are not needed. Typically, the Dammann gratings are mounted on a stage that is rotatable about the optic beam axis. In using Dammann gratings, other modifications may have to be made to other optical elements of the generator within which the grating is installed, and/or to other elements of apparatus 170. Such modifications will be apparent to those skilled in the art, and include addition, removal, and/or repositioning of components in the beams generated by the gratings, such as relay optics 104.

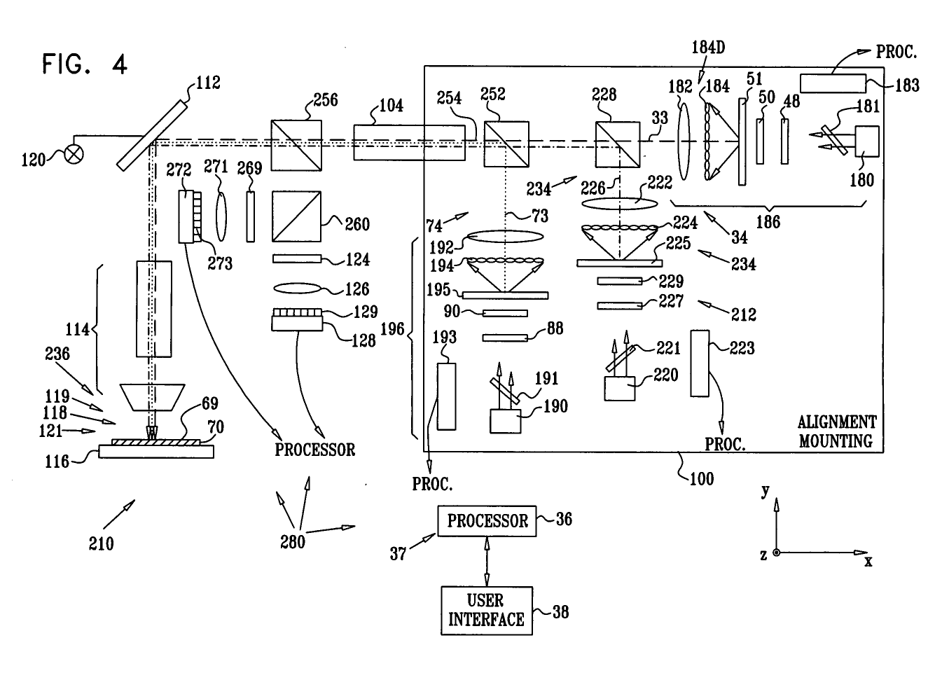

The embodiments described above have used one probe spot for each pump spot in array 118. Embodiments of the present invention also comprise more than one probe spot for each pump spot in the array of spots formed on surface 69. Typically, the multiple probe spots are formed by replicating the probe beam generators described above, and mounting the replicated generators on alignment mounting 100. An example of a multiple probe spot apparatus is described with respect to FIG. 4 below.

FIG. 4 is a schematic diagram illustrating a wafer inspection apparatus 210, according to an embodiment of the present invention. Apart from the differences described below, the operation of apparatus 210 is generally similar to that of apparatus 170 (FIG. 3), such that elements indicated by the same reference numerals in apparatus 210 and apparatus 170 are generally identical in construction and in operation.

Apparatus 210 comprises a second probe beam generator 212, which is generally the same in configuration and operation as generator 196, comprising a single probe source 220, a beam splitter 221, elements 227 and 229, a beam expander 225, a set of micro-lenses 224, a converging lens 222, and a detector 223, which are respectively substantially similar in operation to components 190, 191, 88, and 90, 195, 194, 192, and 193. Generator 212 generates a plurality of second probe beams 234, and a broken line 226 illustrates a path of the second probe beams through apparatus 210. Source 220 operates at a different wavelength from that of source 190 and source 180, typically within a range of 600 nm-800 nm. The signal from detector 223 enables normalization of the image processing performed by unit 280. Radiation from generator 212 is combined with that of generator 186 using a dichroic beam splitter 228, which transmits the pump wavelength and reflects the second probe beam wavelength generated by source 220.

Set of micro-lenses 224 is substantially similar to set 194, so that second probe beams 234 are the same in number as the plurality of pump beams 34, and have substantially the same geometric relationship with each other as the plurality of pump beams. Processor 36 configures respective micro-lenses 224 and 184 to have a same second respective effective spatial offset. Furthermore, processor 36 sets a second beam offset of each of the second probe beams 234 relative to pump beams 34; the second beam offset may be the same or different from the beam offset of first probe beams 74 from the pump beams.

A beam splitter 252 has generally similar characteristics as beam splitter 52, and in addition is transparent to second probe beam radiation. A beam bundle 254 formed by splitter 252 thus comprises pump beams 34, first probe beams 74, and second probe beams 234. Array 118 generated by bundle 254 consequently comprises sub-arrays 119 of pump spots, sub-arrays 121 of first probe spots, and sub-arrays 236 of second probe spots formed from second probe beams 234. Processor 36 adjusts generator 212 so that an offset between sub-arrays 236 and sub-arrays 119 is given by a vector P₂, defined by equation (3). Each component x₂, z₂, of the vector typically has the same order of magnitude as the components of vector P₁.
P₂=(x₂,z₂); x₂,z₂,ε R (3)

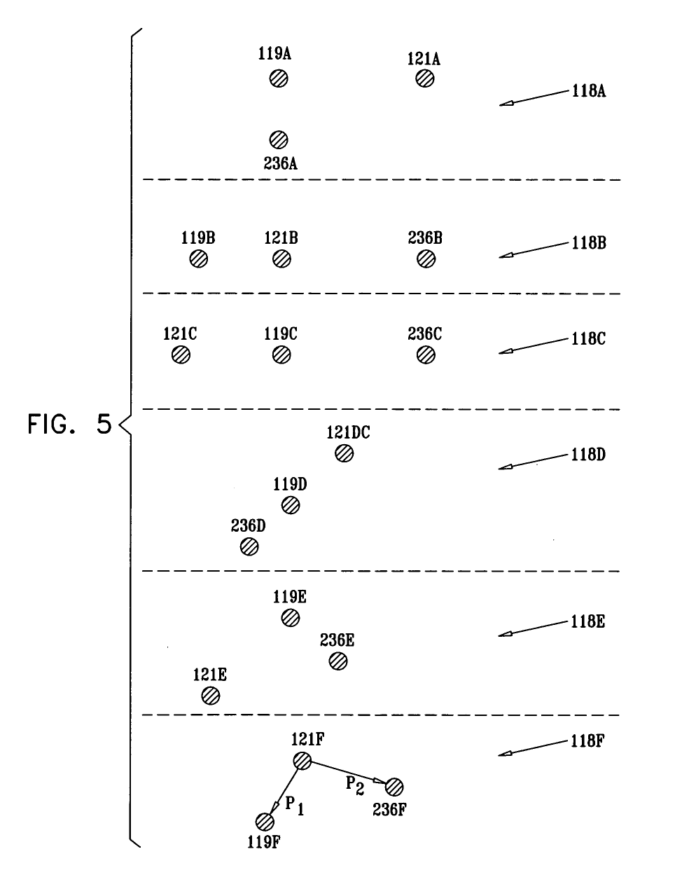

Examples of offsets of P₁ and P₂ that may be used in apparatus 210 are described in FIG. 5, below.

The returning radiation for apparatus 210 comprises specular and scattered radiation from the pump spots, and from the first and second probe spots of array 118. For clarity, only elements for detecting the specular radiation are shown in FIG. 4; those skilled in the art will be able to apply the description herein for detecting the scattered radiation.

A beam splitter 256 is generally similar to splitter 106, and in addition partially reflects second probe beam radiation. Thus, splitter 256 reflects specular first and second probe beam radiation to a dichroic beam splitter 260, which transmits the first probe specular returning radiation, as is described above with reference to FIG. 1, to device 128. Splitter 260 reflects the second probe specular returning radiation via components 269, 271, and 273, substantially similar respectively to components 124, 126, and 129, to an imaging device 272. Device 272 detects the specular second probe wavelength returning radiation.

Devices 128, 272, and processor 36 act as a receiving unit 280, generally similar to unit 140 described above, for apparatus 210. It will be understood that when scattered radiation is detected, unit 280 comprises detectors that receive and detect the scattered radiation.

It will be appreciated that, as for the embodiments described above with reference to FIGS. 1 and 3, Dammann gratings, may be used in place of the arrays of micro-lenses described above. Thus, by way of example, Dammann grating 184D may be incorporated into generator 186 instead of micro-lenses 184. The grating is typically mounted on a rotatable stage.

It will be understood that apparatus 210 is one example of apparatus having multiple probe spots for a pump spot, and that the scope of the present invention includes other apparatus wherein more than two probe spots are generated per pump spot. It will also be understood that the probe generators and/or pump generators required for embodiments of the present invention do not need to be of the same configuration, so that, for example, an inspection apparatus may comprise a pump generator similar to generator 186 (FIG. 3) and a probe generator similar to generator 94 (FIG. 1). Other configurations of generators of multiple pump and/or probe beams will be apparent to those skilled in the art, as will other systems for combining the multiple beams so as to produce arrays of multiple pump and probe spots. All such configurations and systems are assumed to be comprised within the scope of the present invention.

It will also be understood that the approach of apparatus 210, wherein multiple probe wavelengths are used, may also be applied in the embodiment of FIG. 1. In this case, a further set of probe lasers, substantially similar to the set of lasers 64, is used. The further set operates at a wavelength different from that of lasers 64.

FIG. 5 illustrates spot offsets that may be applied by processor 36 to array 118 in apparatus 210, according to an embodiment of the present invention. The offsets are illustrated in diagrams 118A-118F, the suffixes A, B, . . . F being applied respectively to each pump spot 119, and first and second probe spots 121 and 236. Each set of spots irradiates a specific location 125 (FIG. 2A) on surface 69. Table I below shows properties of the spot offsets, the subscripts A, B, . . . F being used to identify the coordinates of the vectors.

TABLE I

| | Spot Offset | | Angle between | Angle of P₁ |
|---|---|---|---|---|
| Diagram | P₁ | P₂ | P₁ and P₂ | with x axis |
| 118A | (x_{A}, 0) | (0, z_{A}) | 90° | 0° |
| 118B | (x_{1B}, 0) | (x_{2B}, 0) | 0° | 0° |
| 118C | (x_{1C}, 0) | (x_{2C}, 0) | 180° | 0° |
| 118D | (x_{1D}, z_{1D}) | (x_{2D}, z_{2D}) | 180° | 45° |
| 118E | (x_{1E}, z_{1E}) | (x_{2E}, z_{2E}) | 90° | −135° |
| 118F | (x_{1F}, z_{1F}) | (x_{2F}, z_{2F}) | 0°-360° | 0°-360° |

It will be understood that while for clarity diagrams 118A-118F show their respective spots 119, 121, and 236 as being separated, the spots may partially or completely overlap. It will also be understood that diagrams 118A-118E are illustrative of some special cases of vectors P₁ and P₂, and that, as exemplified by diagram 118F, in general the angles between the vectors may comprise any value between 0° and 360°, that the angles made by the vectors with the x or z axis may also comprise any value between 0° and 360°, and that the lengths of the vectors may be any value equal to or greater than zero.

In operating apparatus 210, processor 36 inspects wafer 70 by scanning the arrays 118 produced over areas 158, substantially as described above with respect to FIG. 2B. The processor generates reflectivity metrics using signals from the two probe radiations, generally as described above for the metrics derived from a single probe radiation.

Returning to FIGS. 2A and 2B, it will be appreciated that in embodiments of the present invention, processor 36 may set the scanning parameters for each area 138, including the values of P₁ and/or P₂, and/or the type of scan applied by mirror 112 to the area, according to the features of the location being scanned. As a first example, if the area 158 being scanned comprises a large number of conductive lines, typically metal lines, in the x direction, P₁ and/or P₂ may both be set parallel to the x-axis, and the scan may be a raster scan substantially similar to scan 152. As a second example, if the area 158 comprises a large number of metal lines at 45° to the x-axis, P₁ and/or P₂ may be set at 45° to the x-axis, and the scan may also be configured to comprise scans at 45° to the x-axis. As a third example, in an area comprising conductive and non-conductive areas, the polarization of the incoming pump and/or probe beams may be set to improve the signal-to-noise of the reflectivity metric of the conductive areas compared to the non-conductive areas. Other settings for scanning parameters, according to the features of the region or area being scanned, will be apparent to those skilled in the art.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

We claim:

1. Apparatus for inspecting a surface, comprising:
a plurality of pump sources having respective pump optical output ends and providing respective pump beams through the pump optical output ends;
a plurality of probe sources having respective probe optical output ends and providing respective probe beams through the probe optical output ends;
an alignment mounting which holds the respective pump optical output ends and probe optical output ends in equal respective effective spatial offsets;
optics which convey the respective pump beams and probe beams to the surface, so as to generate returning radiation from a plurality of respective locations thereon, and which convey the returning radiation from the respective locations; and
a receiving unit which is adapted to receive the returning radiation and which is adapted to determine a characteristic of the respective locations in response thereto.

2. The apparatus according to claim 1, wherein the plurality of pump sources operate at a pump wavelength, and wherein the plurality of probe sources operate at a probe wavelength different from the pump wavelength.

3. The apparatus according to claim 1, wherein each of the respective pump beams is modulated at a modulation frequency, and wherein the returning radiation comprises returning radiation, from the probe beams conveyed to the surface, at the modulation frequency.

4. The apparatus according to claim 1, wherein the optics convey the respective pump beams and probe beams to the surface so as to form respective sets of spots at the respective locations.

5. The apparatus according to claim 1, wherein each pump source comprises a pump radiation source coupled to convey the respective pump beam into a fiber optic having a transmitting end, and wherein the pump optical output end comprises the transmitting end.

6. The apparatus according to claim 1, wherein each probe source comprises a probe radiation source coupled to convey the respective probe beam into a fiber optic having a transmitting end, and wherein the probe optical output end comprises the transmitting end.

7. The apparatus according to claim 1, wherein the alignment mounting comprises a probe mount which holds the probe optical output ends and a pump mount which holds the pump optical output ends, and wherein the probe mount and the pump mount have the same geometric configuration.

8. The apparatus according to claim 1, wherein the optics comprise a scanning unit which is adapted to implement a scan of the respective pump beams and probe beams across the surface, and wherein the plurality of respective locations comprise a plurality of areas of the surface determined in response to the scan.

9. The apparatus according to claim 1, wherein at least one of the plurality of pump sources and the plurality of probe sources comprises a Dammann grating.

10. Apparatus for inspecting a surface, comprising:
a pump source which generates pump radiation;
a plurality of transparent pump elements arranged to receive different respective pump portions of the pump radiation and to output the respective pump portions as respective pump beams;
a probe source which generates probe radiation;
a plurality of transparent probe elements arranged to receive different respective probe portions of the probe radiation and to output the respective probe portions as respective probe beams;
an alignment mounting which holds the respective transparent pump elements and the respective transparent probe elements in equal respective effective spatial offsets;
optics which convey the respective pump beams and probe beams to the surface, so as to generate returning radiation from a plurality of respective locations thereon, and which convey the returning radiation from the respective locations; and
a receiving unit which is adapted to receive the returning radiation and which is adapted to determine a characteristic of the respective locations in response thereto.

11. The apparatus according to claim 10, wherein the pump radiation has a pump wavelength, and wherein the probe radiation has a probe wavelength different from the pump wavelength.

12. The apparatus according to claim 10, wherein each of the respective pump beams is modulated at a modulation frequency, and wherein the returning radiation comprises returning radiation, from the probe beams conveyed to the surface, at the modulation frequency.

13. The apparatus according to claim 10, wherein the optics convey the respective pump beams and probe beams to the surface so as to form respective sets of spots at the respective locations.

14. The apparatus according to claim 10, wherein the optics comprise a scanning unit which is adapted to implement a scan of the respective pump beams and probe beams across the surface, and wherein the plurality of respective locations comprise a plurality of areas of the surface determined in response to the scan.

15. The apparatus according to claim 10, wherein at least one of the plurality of transparent pump elements and the plurality of transparent probe elements comprises a Dammann grating.

16. Apparatus for inspecting a surface, comprising:
a pump source which is adapted to irradiate a location on the surface with a pump beam;
a first probe source which is adapted to perform a first probe irradiation of the location so as to generate first returning radiation therefrom;
a second probe source which is adapted to perform a second probe irradiation of the location so as to generate second returning radiation therefrom; and
a receiving unit which is adapted to receive the first and the second returning radiations and which is adapted to determine a characteristic of the location in response to at least one of the returning radiations.

17. The apparatus according to claim 16, wherein the pump source, the first probe source, and the second probe source operate at different wavelengths.

18. The apparatus according to claim 16, wherein the first probe irradiation is modulated at a modulation frequency, and wherein the receiving unit is adapted to receive the first and the second returning radiations at the modulation frequency.

19. The apparatus according to claim 16, and comprising a polarization element which is adapted to polarize at least one of the pump source, the first probe source, and the second probe source.

20. The apparatus according to claim 16, wherein the location comprises an array of one or more regions on the surface, and wherein for each region the pump source irradiates a pump spot in the region, the first probe source irradiates a first probe spot in the region, and the second probe source irradiates a second probe spot in the region.

21. The apparatus according to claim 16, wherein at least one of the pump source, the first probe source, and the second probe source comprises a Dammann grating.
